(19) United States
(12) Patent Application Publication
(10) Pub. No.: US 2025/0224659 A1
(43) Pub. Date: Jul. 10, 2025

(54) ILLUMINATION SYSTEM AND PROJECTION DEVICE

(71) Applicant: Coretronic Corporation, Hsin-Chu (TW)

(72) Inventor: Min-Chang Chang, Hsin-Chu (TW)

(73) Assignee: Coretronic Corporation, Hsin-Chu (TW)

(21) Appl. No.: 18/979,529

(22) Filed: Dec. 12, 2024

(30) Foreign Application Priority Data
Jan. 4, 2024 (CN) 202410010638.7

(51) Int. Cl. G03B 21/20

(52) U.S. Cl. CPC G03B 21/204; G03B 21/2066; G03B 21/208

(57) ABSTRACT

An illumination system including an excitation light source, a wavelength conversion device, a first light splitting module, a second light splitting module, a first light homogenizing element, and a second light homogenizing element is provided. Here, the excitation light source is configured to provide a laser beam. The wavelength conversion device is configured to convert the laser beam into an excited beam or a reflected laser beam at different timing. The first light splitting module is configured to reflect a first sub-laser beam of the laser beam from the wavelength conversion device to the first light homogenizing element. The second light splitting module is configured to reflect a second sub-laser beam from the first light splitting module to the second light homogenizing element. An illumination beam includes the first sub-laser beam, the second sub-laser beam, and the excited beam.

### CROSS-REFERENCE TO RELATED APPLICATION

This application claims the priority benefit of China application serial no. 202410010638.7, filed on Jan. 4, 2024. The entirety of the above-mentioned patent application is hereby incorporated by reference herein and made a part of this specification.

### BACKGROUND OF THE INVENTION

### Field of the Invention

The invention relates to an optical system and an electronic device; more particularly, the invention relates to an illumination system and a projection device.

### Description of Related Art

As technology strides forward, a projection device standing as a display device for generating expansive images undergoes a continual evolution. Fundamentally, the imaging mechanism of the projection device is to convert an illumination beam emitted by an illumination system into an image beam via a light valve. Subsequently, the image beam is projected onto a designated target (e.g., a screen or a wall) by means of a projection lens, thereby forming a desired image. Besides, the illumination system has witnessed a progression from ultra-high-performance (UHP) lamps and light-emitting diodes (LEDs) to the cutting-edge laser diode (LD) light sources. What is more, the introduction of multi-in-one packaged light sources, forged from the LD, has contributed to a more streamlined internal configuration of the projection device, enhancing its optical performance. These advancements align with market demands for heightened brightness, enriched color saturation, prolonged service life, and environmentally-friendly attributes within projection devices.

Within the existing combiner system, the design of a light path causes a blue beam to enter an integration rod at an excessive angle, resulting in diminished or absent blue beam at a central angle of the integration rod. Consequently, the uniformity of the blue beam suffers. Moreover, due to the shared passage of the converted excited beam and the blue beam through the same integration rod, efforts to independently optimize the uniformity of the excited beam and the blue beam are hindered.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

In order to achieve one, some, or all of the aforementioned objectives or other objectives, an embodiment of the invention provides an illumination system configured to provide an illumination beam and include an excitation light source, a wavelength conversion device, a first light splitting module, a second light splitting module, a first light homogenizing element, and a second light homogenizing element. The excitation light source is configured to provide a laser beam. The wavelength conversion device is disposed on a transmission path of the laser beam and configured to convert the laser beam into an excited beam or reflect the laser beam at different timing. The first light splitting module is disposed between the wavelength conversion device and the second light splitting module and configured to allow the laser beam from the excitation light source to pass through, reflect a first sub-laser beam of the laser beam from the wavelength conversion device to the first light homogenizing element, and allow a second sub-laser beam of the laser beam from the wavelength conversion device to pass through. The second light splitting module is disposed between the excitation light source and the first light splitting module and configured to allow the laser beam from the excitation light source to pass through and reflect the second sub-laser beam from the first light splitting module to the second light homogenizing element. The first light homogenizing element is disposed on a transmission path of the first sub-laser beam from the first light splitting module. The second light homogenizing element is configured on a transmission path of the second sub-laser beam from the second light splitting module, and the illumination beam includes the first sub-laser beam, the second sub-laser beam, and the excited beam.

In order to achieve one, some, or all of the aforementioned objectives or other objectives, another embodiment of the invention provides a projection device that includes an illumination system, at least one light valve, and a projection lens. The illumination system is configured to provide an illumination beam and includes an excitation light source, a wavelength conversion device, a first light splitting module, a second light splitting module, a first light homogenizing element, and a second light homogenizing element. The excitation light source is configured to provide a laser beam. The wavelength conversion device is disposed on a transmission path of the laser beam and configured to convert the laser beam into an excited beam or reflect the laser beam at different timing. The first light splitting module is disposed between the wavelength conversion device and the second light splitting module and configured to allow the laser beam from the excitation light source to pass through, reflect a first sub-laser beam of the laser beam from the wavelength conversion device to the first light homogenizing element, and allow a second sub-laser beam of the laser beam from the wavelength conversion device to pass through. The second light splitting module is disposed between the excitation light source and the first light splitting module and configured to allow the laser beam from the excitation light source to pass through and reflect the second sub-laser beam from the first light splitting module to the second light homogenizing element. The first light homogenizing element is disposed on a transmission path of the first sub-laser beam from the first light splitting module. The second light homogenizing element is configured on a transmission path of the second sub-laser beam from the second light splitting module, and the illumination beam includes the first sub-laser beam, the second sub-laser beam, and the excited beam. The at least one light valve is disposed on a transmission path of the illumination beam and configured to convert the illumination beam into an image beam. The projection lens is disposed on a transmission path of the image beam and configured to project the image beam out of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1D are schematic views illustrating a projection device at different timing according to an embodiment of the invention.

FIG. 2 is a schematic view illustrating a wavelength conversion device of the projection device depicted in FIG. 1A.

FIG. 3 is a schematic view illustrating a first filter device of the projection device depicted in FIG. 1A.

FIG. 4 is a schematic view illustrating an illumination system according to another embodiment of the invention.

FIG. 5 is a schematic view illustrating an illumination system according to another embodiment of the invention.

FIG. 6 is a schematic view illustrating an illumination system according to another embodiment of the invention.

FIG. 7 is a schematic view illustrating an illumination system according to another embodiment of the invention.

FIG. 8 is a schematic view illustrating an illumination system according to another embodiment of the invention.

FIG. 9 is a schematic view illustrating an illumination system according to another embodiment of the invention.

FIG. 10 is a schematic view illustrating an illumination system according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

According to one or more embodiments of the invention, an illumination system and a projection device that may increase the blue beam that traverses through the center of light homogenizing elements, thereby enhancing the uniformity of the blue beam within the illumination beam and effectively addressing the challenge of inadequate distribution of the blue beam within the central angular space of the light homogenizing elements, as observed in conventional optical structures.

Other objectives and advantages of this invention may be further understood from the technical features disclosed in this invention.

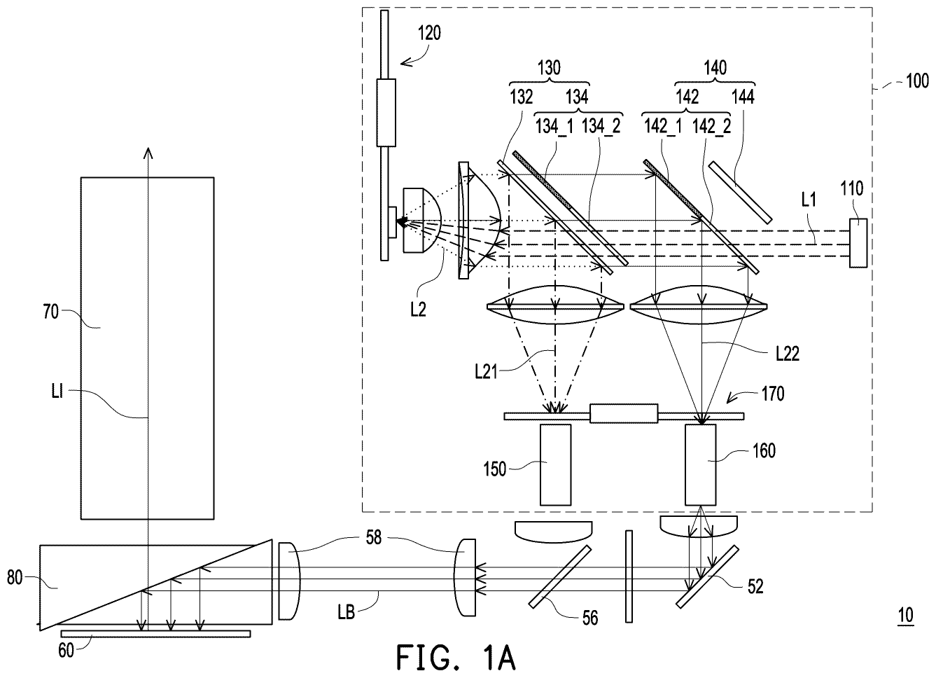

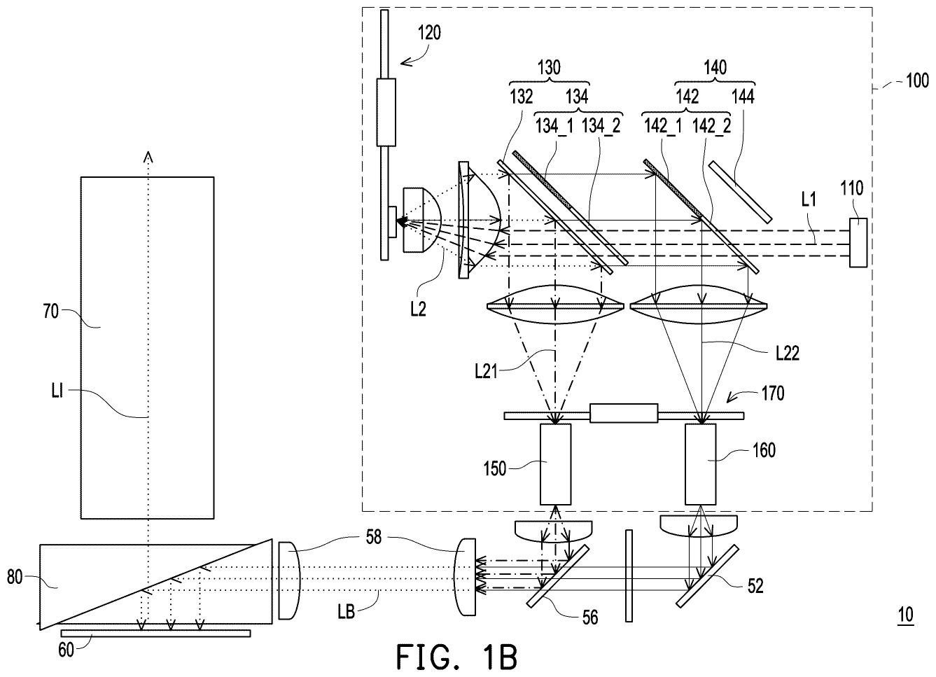

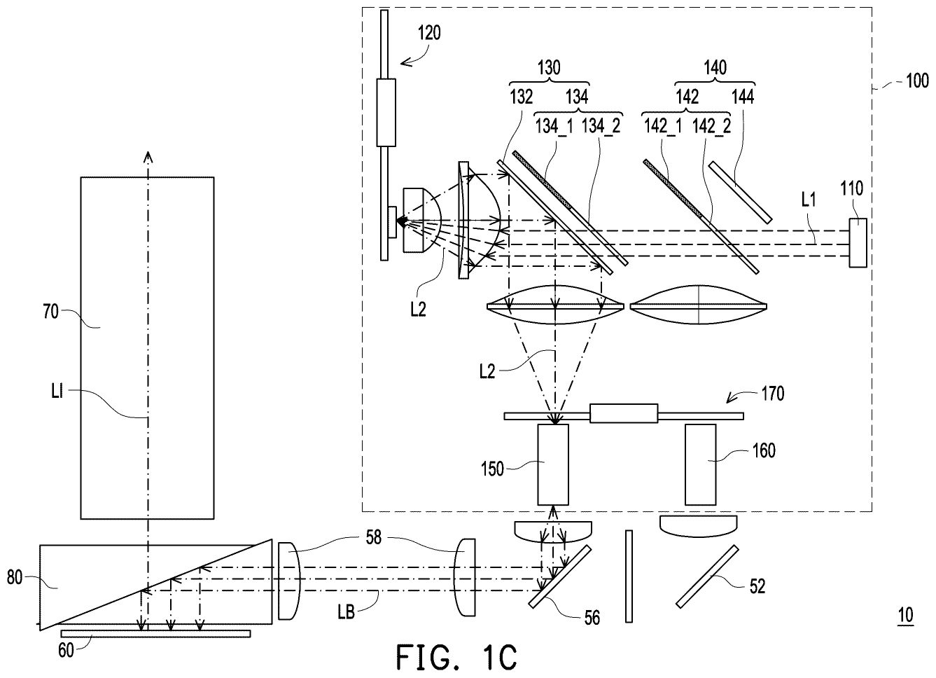

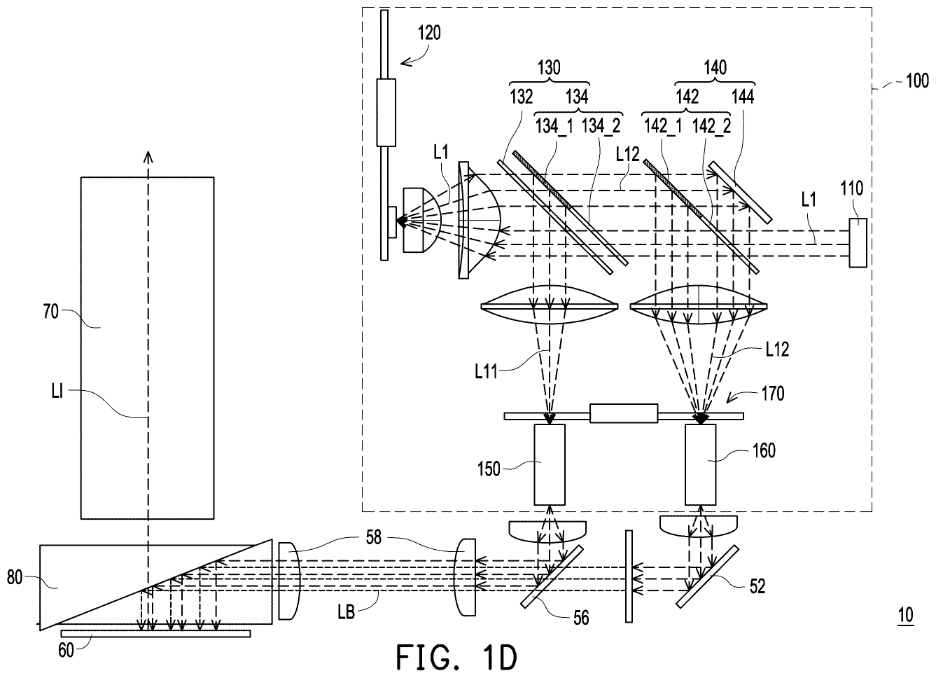

FIG. 1A to FIG. 1D are schematic views illustrating a projection device at different timing according to an embodiment of the invention. With reference to FIG. 1A, a projection device 10 is provided in this embodiment, and the projection device 10 includes an illumination system 100, at least one light valve 60, and a projection lens 70. The illumination system 100 is configured to provide an illumination beam LB. The at least one light valve 60 is disposed on a transmission path of the illumination beam LB and configured to convert the illumination beam LB into an image beam LI. The projection lens 70 is disposed on a transmission path of the image beam LI and is configured to project the image beam LI out of the projection device 10 to a projection target (not shown), such as a screen or a wall.

The light valve 60 is, for instance, a reflective light modulator, such as a liquid crystal on silicon panel (LCOS panel), a digital micro-mirror device (DMD), and so on. In some embodiments, the light valve 60 may also be a transmissive light modulator, such as a transparent liquid crystal panel, an electro-optical modulator, a magneto-optic modulator, an acousto-optic modulator (AOM), and so on. The type and kind of the light valve 60 should not be construed as a limitation to the invention. A method of converting the illumination beam LB into the image beam LI by the light valve 60 may be performed by guiding light beams through a total internal reflection prism (TIR prism or RTIR prism) 80. Detailed steps of this method and the implementation manner may be sufficiently taught, suggested, and implemented by people having ordinary skill in the pertinent art and thus are not further elaborated. In different embodiments, the number of the light valves 60 may be designed to be one to three, which should not be construed as a limitation to the invention.

The projection lens 70, for instance, includes a combination of one or more optical lenses with refractive power, such as various combinations of non-planar lenses including biconcave lenses, biconvex lenses, concave-convex lenses, convex-concave lenses, plano-convex lenses, plano-concave lenses, and the like. In an embodiment, the projection lens 70 may also include a planar optical lens to project the image beam LI from the light valve 60 to the projection target in a reflective manner. The type and kind of the projection lens 70 should not be construed as a limitation to the invention. Moreover, in a light path from the illumination system 100 to the projection lens 70, different types and quantities of optical elements may be arranged to guide the direction in which the light beam is transmitted according to different machine designs. For instance, a reflective mirror 52, a beam splitter 56, an optical lens 58, and other optical elements may be disposed on the light path, which should however not be construed as a limitation to the invention.

The illumination system 100 includes an excitation light source 110, a wavelength conversion device 120, a first light splitting module 130, a second light splitting module 140, a first light homogenizing element 150, and a second light homogenizing element 160. Here, the excitation light source 110 is configured to provide a laser beam L1. The excitation light source 110 includes at least one LED, at least one LD, or a combination of the two. Specifically, in this embodiment, the excitation light source 110 includes at least one blue LD, and the laser beam L1 is, for instance, a blue laser beam.

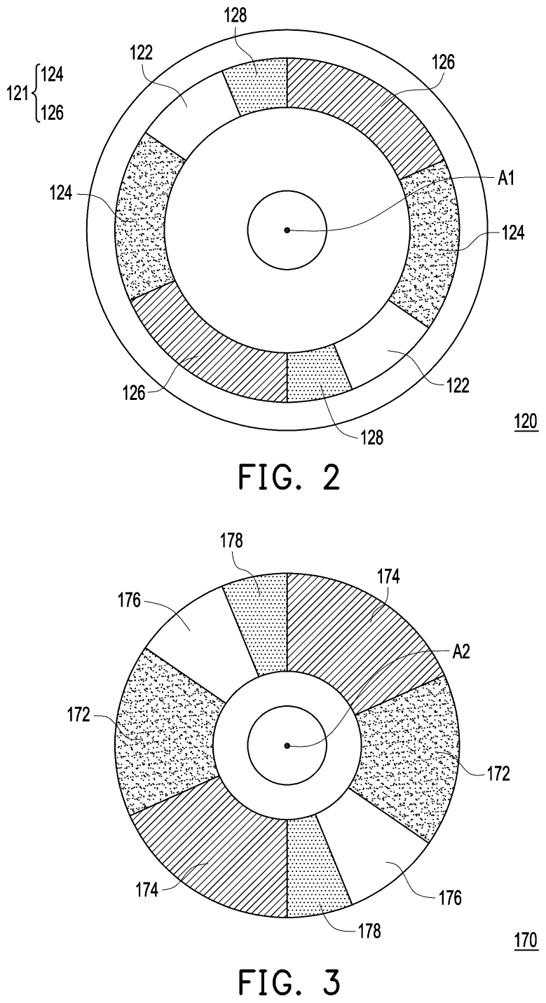

FIG. 2 is a schematic view illustrating a wavelength conversion device of the projection device depicted in FIG. 1A. With reference to FIG. 1A and FIG. 2, the wavelength conversion device 120 is disposed on a transmission path of the laser beam L1 to convert the laser beam L1 into an excited beam L2 or a reflected laser beam L1 at different timing. The wavelength conversion device 120 is, for instance, a color wheel structure and includes at least one first wavelength conversion region 121 and at least one reflective region 122, which are alternately arranged around a rotation axis A1. The wavelength conversion device 120 includes a driver component (not marked), and the driver component may be a motor that drives the wavelength conversion device 120 to rotate around the rotation axis A1, so that the at least one first wavelength conversion region 121 and the at least one reflective region 122 are moved onto the transmission path of the laser beam L1 at different timing. In the present embodiment, the wavelength conversion device 120 has two first wavelength conversion regions 121 and two reflective regions 122, which are symmetrically arranged around the rotation axis A1, and the number of the first wavelength conversion regions 121 and the reflective regions 122 is not limited in the invention. The first wavelength conversion regions 121, for instance, include a yellow phosphor material for converting the blue laser beam L1 into a yellow excited beam L2. The reflective regions 122 are, for instance, substrates with high reflectivity or equipped with a reflective mirror for reflecting the laser beam L1.

In the present embodiment, the first wavelength conversion regions 121 may be further designed to be divided into a first sub-wavelength conversion region 124 and a second sub-wavelength conversion region 126. The first sub-wavelength conversion region 124, for instance, includes a green phosphor material for converting the blue laser beam L1 into a green excited beam L2, thereby further increasing the color gamut of the green beam waveband. However, in different embodiments, the green beam within the illumination beam LB may still be obtained through yellow beam after color separation, which should however not be construed as a limitation to the invention. The second sub-wavelength conversion region 126, for instance, includes a yellow or red phosphor material for converting the blue laser beam L1 into a yellow or red excited beam L2. Specifically, when the second sub-wavelength conversion region 126 includes the yellow phosphor material, the corresponding converted excited beam L2 is yellow, and the red beam within the illumination beam LB may be obtained through yellow beam color separation; when the second sub-wavelength conversion region 126 includes the red phosphor material, the corresponding converted excited beam L2 is red, thereby further increasing the color gamut of the red beam waveband of the illumination beam.

In addition, the wavelength conversion device 120 further includes at least one second wavelength conversion region 128, the number of which should not be construed as a limitation to the invention. In the present embodiment, two second wavelength conversion regions 128 are symmetrically arranged around the rotation axis A1 and, for instance, include the yellow phosphor material for converting the blue laser beam L1 into a yellow excited beam L2, thereby further enhancing the proportion of the yellow beam within the illumination beam LB to improve the overall brightness. The at least one first wavelength conversion region 121, the at least one second wavelength conversion region 128, and the at least one reflective region 122 of the wavelength conversion device 120 are, for instance, arranged in a ring shape around the rotation axis A1. In an embodiment, a conversion wavelength of the at least one second wavelength conversion region 128 may be designed to be different from a conversion wavelength of the first wavelength conversion region 121 (or the second sub-wavelength conversion region 126). For instance, the conversion wavelength of the second wavelength conversion region 128 may be designed to be shorter than the conversion wavelength of the second sub-wavelength conversion region 126, so that the blue laser beam L1 is converted into a yellow excited beam L2 with a shorter wavelength by the second wavelength conversion region 128 to improve brightness, and the blue laser beam L1 is converted into a yellow excited beam L2 with a longer wavelength by the second sub-wavelength conversion region 126, which is beneficial for subsequently generating more red beam on the light path. However, in some embodiments, the conversion wavelength of the second wavelength conversion region 128 may also be designed to be the same as the conversion wavelength of the first wavelength conversion region 121 (or the second sub-wavelength conversion region 126) by using the same wavelength conversion material, for instance, which should not be construed as a limitation to the invention.

As shown in FIG. 1A to FIG. 1D, the first light splitting module 130 is disposed between the wavelength conversion device 120 and the second light splitting module 140 and configured to allow the laser beam L1 from the excitation light source 110 to pass through, reflect a first sub-laser beam L11 of the laser beam L1 from the wavelength conversion device 120 to the first light homogenizing element 150, and allow a second sub-laser beam L12 of the laser beam L1 from the wavelength conversion device 120 to pass through (as shown in FIG. 1D). Here, the first sub-laser beam L11 is one portion of the laser beam L1 from the wavelength conversion device 120, and the second sub-laser beam L12 is the other portion of the laser beam L1 from the wavelength conversion device 120. In the present embodiment, the first light splitting module 130 includes a first light splitting element 132 and a semi-reflective and semi-transmissive element 134. Here, the first light splitting element 132 is disposed between the semi-reflective and semi-transmissive element 134 and the wavelength conversion device 120 and configured to reflect a first portion L21 of the excited beam L2, transmit the first portion L21 of the excited beam L2 toward the first light homogenizing element 150, and allow a second portion L22 of the excited beam L2 and the laser beam L1 to pass through. A wavelength of the first portion L21 is different from a wavelength of the second portion L22. In the present embodiment, the first light splitting element 132 is, for instance, a dichroic mirror with green reflect (DMG).

The semi-reflective and semi-transmissive element 134 is disposed between the first light splitting element 132 and the second light splitting module 140 and configured to allow the second sub-laser beam L12 of the laser beam L1 from the first light splitting element 132 and the second portion L22 of the excited beam L2 to pass through and reflect the first sub-laser beam L11 of the laser beam L1 from the first light splitting element 132 to the first light homogenizing element 150. More specifically, in the present embodiment, the semi-reflective and semi-transmissive element 134 includes a semi-reflective and semi-transmissive region 134_1 and a total transmissive region 134_2 that are arranged adjacently. Here, the semi-reflective and semi-transmissive region 134_1 is located on the transmission path of the laser beam L1 from the first light splitting element 132 and configured to allow the second sub-laser beam L12 of the laser beam L1 from the first light splitting element 132 and the second portion L22 of the excited beam L2 to pass through (as shown in FIG. 1A, FIG. 1B, and FIG. 1D) and reflect the first sub-laser beam L11 of the laser beam L1 from the first light splitting element 132 (as shown in FIG. 1D). In the present embodiment, the semi-reflective and semi-transmissive region 134_1 is, for instance, a semi-transmissive and semi-reflective mirror for the blue beam; namely, the semi-reflective and semi-transmissive region 134_1 has semi-transmissive and semi-reflective characteristics only for the laser beam L1 and has total transmissive characteristics for the excited beam L2. The total transmissive region 134_2 is located on the transmission path of the laser beam L1 between the excitation light source 110 and the wavelength conversion device 120 and configured to allow the laser beam L1 to pass through. In the present embodiment, the total transmissive region 134_2 is a transparent plate or an air frame, or no element is disposed in the total transmissive region 134_2, for instance, which should however not be construed as a limitation to the invention.

The second light splitting module 140 is disposed between the excitation light source 110 and the first light splitting module 130 and configured to allow the laser beam L1 from the excitation light source 110 to pass through and reflect the second sub-laser beam L12 from the first light splitting module 130 to the second light homogenizing element 160 (as shown in FIG. 1D). In the present embodiment, the second light splitting module 140 includes a second light splitting element 142 and a reflective element 144. The second light splitting element 142 is disposed between the reflective element 144 and the first light splitting module 130 and configured to reflect the second portion L22 of the excited beam L2 from the first light splitting module 130 (as shown in FIGS. 1A and 1B), transmit the second portion L22 of the excited beam L2 to the second light homogenizing element 160, and allow the second sub-laser beam L12 from the first light splitting module 130 to pass through (as shown in FIG. 1D). In the present embodiment, the second light splitting element 142 includes a semi-reflective and semi-transmissive region 142_1 and a total transmissive region 142_2, the implementation manner of which is similar to that of the semi-reflective and semi-transmissive region 134_1 and the total transmissive region 134_2 of the semi-reflective and semi-transmissive element 134 and thus will not be further described. Note that the semi-reflective and semi-transmissive region 142_1 of the second light splitting element 142 is a semi-transmissive and semi-reflective mirror for the blue beam, for instance, but the difference between the semi-reflective and semi-transmissive region 142_1 and the semi-reflective and semi-transmissive region 134_1 of the semi-reflective and semi-transmissive element 134 lies in that the semi-reflective and semi-transmissive region 142_1 of the second light splitting element 142 has semi-transmissive and semi-reflective characteristics for the laser beam L1 and has a total reflective characteristics for the excited beam L2 (or the second sub-laser beam L12). In other embodiments, the second light splitting element 142 includes but is not limited to a single dichroic mirror with green and red reflect (DMGR), for instance. The reflective element 144 is disposed between the second light splitting element 142 and the excitation light source 110 to reflect the second sub-laser beam L12 from the first light splitting module 130 to the second light homogenizing element 160. The reflective element 144 is, for instance, a reflective mirror. Therefore, in the present embodiment, the laser beam L1 from the wavelength conversion device 120 may be divided into the first sub-laser beam L11 and the second sub-laser beam L12 by the first light splitting module 130 and the second light splitting module 140, respectively, so as to respectively guide different portions of the laser beam L1 to enter the first light homogenizing element 150 and the second light homogenizing element 160 at different angles. Specifically, the first sub-laser beam L11, which is reflected by the first light splitting module 130, accounts for a larger proportion of the laser beam L1 distributed in the central angle space; that is, in the first sub-laser beam L11, a greater portion of the laser beam L1 enters the center of the first light homogenizing element 150; in the second sub-laser beam L12, which is reflected by the second light splitting module 140, a greater portion of the laser beam L1 enters the second light homogenizing element 160 at larger angles. Accordingly, the quantity of the laser beam (the blue beam) distributed in the central angle space may be effectively increased.

The first light homogenizing element 150 and the second light homogenizing element 160 are, for instance, integration rods configured to adjust the shape of light spots of the light beam, so that the shape of light spots of the illumination beam LB may match the shape (e.g., a rectangular shape) of a working region of the light valve 60, and the light intensity of each light spot may remain consistent or similar, thus homogenizing the light intensity of the illumination beam LB. The first light homogenizing element 150 is disposed on the transmission path of the first sub-laser beam L11 from the first light splitting module 130, and the second light homogenizing element 160 is disposed on the transmission path of the second sub-laser beam L12 from the second light splitting module 140. The illumination beam LB includes the first sub-laser beam L11, the second sub-laser beam L12, and the excited beam L2.

It is worth mentioning that through the optical manipulation facilitated by the first light splitting module 130 and the second light splitting module 140, an incident angle of the first sub-laser beam L11 entering the first light homogenizing element 150 is different from an incident angle of the second sub-laser beam L12 entering the second light homogenizing element 160. As such, blue beam passing through the center of the light homogenizing element may be increased, thereby enhancing the uniformity of the blue beam within the illumination beam and effectively addressing the challenge of inadequate distribution of the blue beam within the central angular space of the light homogenizing elements, as observed in conventional optical structures.

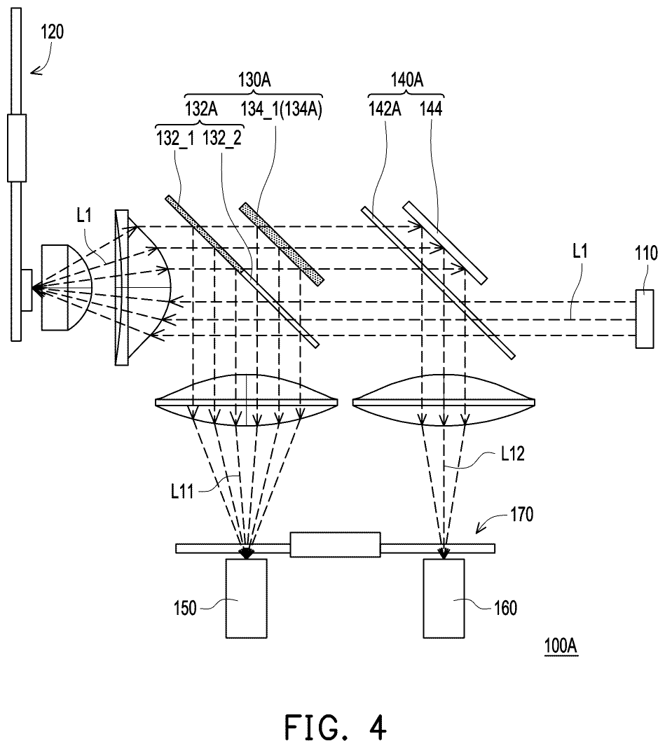

FIG. 3 is a schematic view illustrating a first filter device of the projection device depicted in FIG. 1A. With reference to FIG. 1A to FIG. 1D and FIG. 3, in the present embodiment, the illumination system 100 further includes a first filter device 170 disposed between the first light splitting module 130 and the first light homogenizing element 150 and between the second light splitting module 140 and the second light homogenizing element 160. Specifically, the first filter device 170 is, for instance, a color wheel structure, and two symmetrical side regions in the color wheel are respectively located on a light transmission path from the first light splitting module 130 to the first light homogenizing element 150 and a light transmission path from the second light splitting module 140 to the second light homogenizing element 160. The first filter device 170 includes a driver component (not marked), and the driver member is, for instance, a motor configured to drive the first filter device 170 to rotate around the rotation axis A2. In the present embodiment, the first filter device 170 includes two first filter regions 172, two second filter regions 174, and two transparent regions 176, which are symmetrically arranged and alternately arranged around a rotation axis A2. Here, the two first filter regions 172 are, for instance, filters that simply allow the green beam to pass through or block all light beams with wavelengths except for the wavelength of the green beam, the two first filter regions 172 are configured to receive the first portion L21 of the excited beam L2 and generate a first color beam (i.e., the green beam), and the excited beam L2 further includes the first color beam. The two second filter regions 174 are, for instance, filters that simply allow the red beam to pass through or block all light beams with wavelengths except for the wavelength of the red beam, the two second filter regions 174 are configured to receive the second portion L22 of the excited beam L2 and generate a second color beam (i.e., the red beam), and the excited beam L2 further includes the second color beam. The two transparent regions 176, for instance, are transparent elements that are hollow, made of glass, or made of any material and containing diffusion particles, and the two transparent regions 176 are configured to allow the first sub-laser beam L11 and the second sub-laser beam L12 to pass through, respectively. In the present embodiment, the first filter device 170 further includes two third filter regions 178 symmetrically arranged around the rotation axis A2, the two third filter regions 178 are, for instance, filters that simply allow the red, yellow, and green beams to pass through or block the blue beam, and the two third filter regions 178 are configured to allow the excited beam L2 to pass through and generate the first color beam and the second color beam.

In addition, a rotation speed of the wavelength conversion device 120 is related to a rotation speed of the first filter device 170. Specifically, in this embodiment, since the wavelength conversion device 120 has two first wavelength conversion regions 121 (two first sub-wavelength conversion regions 124 and two second sub-wavelength conversion regions 126), two reflective regions 122, and two second wavelength conversion regions 128, which are symmetrically arranged around the rotation axis A1, and the two first wavelength conversion regions 121, the two reflective regions 122, and the two second wavelength conversion regions 128 correspond to the two first filter regions 172, the two second filter regions 174, the two transparent regions 176, and the two third filter regions 178, which are symmetrically arranged around the rotation axis A2 in the first filter device 170, the wavelength conversion device 120 and the first filter device 170 have the same rotation speed. At different timing, the first sub-wavelength conversion regions 124 of the wavelength conversion device 120 correspond to the first filter regions 172 of the first filter device 170, the second sub-wavelength conversion regions 126 of the wavelength conversion device 120 correspond to the second filter regions 174 of the first filter device 170, the second wavelength conversion regions 128 of the wavelength conversion device 120 correspond to the third filter regions 178 of the first filter device 170, and the reflective regions 122 of the wavelength conversion device 120 correspond to the transparent regions 178 of the first filter device 170. However, in other embodiments, the wavelength conversion device may also have a first wavelength conversion region (a first sub-wavelength conversion region and a second sub-wavelength conversion region), a reflective region 122, and a second wavelength conversion region 128 arranged around the rotation axis. At this time, the rotation speed of the wavelength conversion device and the rotation speed of the first filter device 170 are different, while the regions in the wavelength conversion device need to correspondingly match the regions in the first filter device 170 as described above at different timing.

Therefore, as shown in FIG. 1A, FIG. 2 and FIG. 3, at a timing of the red beam, if the second sub-wavelength conversion region 126 of the first wavelength conversion region 121 includes the yellow phosphor material, the laser beam L1 is transmitted in sequence from the excitation light source 110 to the second sub-wavelength conversion region 126 of the wavelength conversion device 120 through the second light splitting element 142 (the total transmissive region 142_2), the semi-reflective and semi-transmissive element 134 of the first light splitting module 130 (the total transmissive region 134_2), and the first light splitting element 132, so as to convert the laser beam L1 into the yellow excited beam L2. The yellow excited beam L2 is transmitted to the first light splitting element 132 and is split into a first portion L21 of a green color and a second portion L22 of a red color. The first portion L21 of the green color L21 of the excited beam L2 is reflected by the first light splitting element 132 and transmitted to the second filter region 174 of the first filter device 170 to be blocked and filtered out. The second portion L22 of the red color of the excited beam L2 is transmitted through the semi-reflective and semi-transmissive element 134 of the first light splitting module 130, reflected by the second light splitting element 142, and transmitted to the second filter region 174 of the first filter device 170 to generate the second color beam. At this time, the second filter region 174 may filter the second portion L22 of the red color of the excited beam L2 into a red beam with a better color gamut, which is then transmitted into the second light homogenizing element 160, thereby providing the red beam within the illumination beam LB. In another embodiment, if the second sub-wavelength conversion region 126 of the first wavelength conversion region 121 includes the red phosphor material, the laser beam L1 is converted into the red excited beam L2 in the second sub-wavelength conversion region 126 of the wavelength conversion device 120. At this time, the light transmission path of the red excited beam L2 is the same as that of the second portion L22 of the red color of the excited beam L2 and thus will not be further elaborated hereinafter.

With reference to FIG. 1B, FIG. 2, and FIG. 3, at a timing of the yellow beam, the laser beam L1 is transmitted in sequence from the excitation light source 110 to the second wavelength conversion region 128 of the wavelength conversion device 120 through the second light splitting element 142 (the total transmissive region 142_2), the semi-reflective and semi-transmissive element 134 of the first light splitting module 130 (the total transmissive region 134_2), and the first light splitting element 132, so that the laser beam L1 is converted into the yellow excited beam L2. The yellow excited beam L2 is transmitted to the first light splitting element 132 and is split into a first portion L21 of the green color and a second portion L22 of the red color, where the first portion L21 of the green color of the excited beam L2 is reflected by the first light splitting element 132 and transmitted through the third filter region 178 of the first filter device 170 to generate the first color beam (i.e., the green beam), which is transmitted into the first light homogenizing element 150. The second portion L22 of the red color of the excited beam L2 is transmitted through the semi-reflective and semi-transmissive element 134 of the first light splitting module 130, reflected by the second light splitting element 142, and transmitted to the third filter region 178 of the first filter device 170 to generated the second color beam (i.e., the red beam), which is transmitted into the second light homogenizing element 160. Finally, the yellow beam is generated by the subsequent light combining operations by optical elements, thereby providing the yellow beam of the illumination beam LB.

With reference to FIG. 1C, FIG. 2, and FIG. 3, at a timing of the green beam, the laser beam L1 is in sequence transmitted from the excitation light source 110 to the first sub-wavelength conversion region 124 of the wavelength conversion device 120 through the second light splitting element 142 (the total transmissive region 142_2), the semi-reflective and semi-transmissive element 134 of the first light splitting module 130 (the total transmissive region 134_2), and the first light splitting element 132, so that the laser beam L1 is converted to the green excited beam L2. The green excited beam L2 is reflected by the first light splitting element 132 and transmitted to the first filter region 172 of the first filter device 170 to generate the first color beam. At this time, the first filter region 172 may filter the green excited beam L2 into a green beam with better color gamut, which is transmitted into the first light homogenizing element 150, thereby providing the green beam within the illumination beam LB. In another embodiment, if the first sub-wavelength conversion region 124 of the first wavelength conversion region 121 includes the yellow phosphor material, the laser beam L1 is converted into the yellow excited beam L2 in the first sub-wavelength conversion region 124 of the wavelength conversion device 120. At this time, the yellow excited beam L2 is split into a first portion L21 of the green color and a second portion L22 of the red color when passing through the first light splitting element 132. The light transmission path is the same as what is described above and thus will not be further described here. Note that the first portion L21 of the green color of the excited beam L2 generates the first color beam in the first filter region 172 of the first filter device 170, while the second portion L22 of the red color of the excited beam L2 is blocked and filtered out in the first filter region 172 of the first filter device 170.

With reference to FIG. 1D, FIG. 2, and FIG. 3, at a timing of the blue beam, the laser beam L1 is in sequence transmitted from the excitation light source 110 to the reflective region 122 of the wavelength conversion device 120 through the second light splitting element 142 (the total transmissive region 142_2), the semi-reflective and semi-transmissive element 134 of the first light splitting module 130 (the total transmissive region 134_2), and the first light splitting element 132 to reflect the laser beam L1. The reflected laser beam L1 is transmitted to the semi-reflective and semi-transmissive element 134 through the first light splitting element 132. When the laser beam L1 is transmitted to the semi-reflective and semi-transmissive element 134, it reflects the first sub-laser beam L11 and allows the second sub-laser beam L12 to pass through, where the first sub-laser beam L11 is transmitted through the transparent region 176 of the first filter device 170 and enters the first light homogenizing element 150. The second sub-laser beam L12 is reflected by the second light splitting module 140 and transmitted to the transparent region 176 of the first filter device 170 and enters the second light homogenizing element 160. The laser beam L1 entering the first light homogenizing element 150 and the second light homogenizing element 160 is subsequently integrated by optical elements to provide the blue beam within the illumination beam LB. In the present embodiment, since the second light splitting element 142 includes the semi-reflective and semi-transmissive region 142_1 and the total transmissive region 142_2, one part of the second sub-laser beam L12 is reflected and enters the transparent region 176 of the first filter device 170 when passing through the semi-reflective and semi-transmissive region 142_1 of the second light splitting element 142, while the other part of the second sub-laser beam L12 passes through the semi-reflective and semi-transmissive region 142_1 and is reflected by the reflective element 144 to enter the transparent region 176 of the first filter device 170. Thereby, the laser beam L1 may enter the light homogenizing element at different incident angles; that is, the incident angle of the first sub-laser beam L11 entering the first light homogenizing element 150 and the incident angle of the second sub-laser beam L12 entering the second light homogenizing element 160 are different, which may increase the blue beam passing through the center of the light homogenizing element, thereby enhancing the uniformity of the blue beam within the illumination beam LB.

FIG. 4 is a schematic view illustrating an illumination system according to another embodiment of the invention. With reference to FIG. 4, the light transmission path at the timing of the blue beam is shown. An illumination system 100A provided in this embodiment is similar to the illumination system 100 depicted in FIG. 1A. The difference between the two lies in that a first light splitting module 130A provided in this embodiment includes a first light splitting element 132A and a semi-reflective and semi-transmissive element 134A. The first light splitting element 132A includes a semi-reflective and semi-transmissive region 132_1, which reflects the green beam and is semi-transmissive and semi-reflective to the blue beam, and a total transmissive region 132_2. The semi-reflective and semi-transmissive element 134A simply includes a semi-reflective and semi-transmissive region 134_1. The second light splitting module 140A includes the second light splitting element 142A and the reflective element 144. The second light splitting element 142A is a beam splitting mirror which simply reflecting green and red beams. As such, more first sub-laser beam L11 may enter the first light homogenizing element 150 at different angles, and more second sub-laser beams L12 with central angle spatial distribution may enter the second light homogenizing element 160, so as to increase the blue beam passing through the center of the light homogenizing element, thereby enhancing the uniformity of the blue beam within the illumination beam and effectively addressing the challenge of inadequate distribution of the blue beam within the central angular space of the light homogenizing elements, as observed in conventional optical structures.

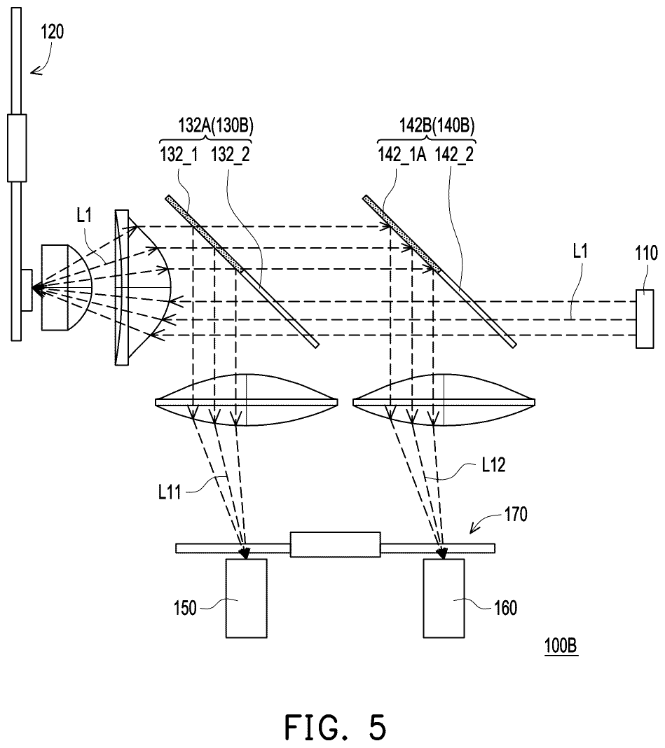

FIG. 5 is a schematic view illustrating an illumination system according to another embodiment of the invention. With reference to FIG. 5, the light transmission path at the timing of the blue beam is shown. An illumination system 100B provided in this embodiment is similar to the illumination system 100 depicted in FIG. 1A. The difference between the two lies in that a first light splitting module 130B provided in this embodiment simply includes the first light splitting element 132A as provided in the embodiment depicted in FIG. 4. The second light splitting module 140B simply includes the second light splitting element 142B, and the second light splitting element 142B includes a reflective region 142_1A and a total transmissive region 142_2 as provided in the embodiment depicted in FIG. 1A, where the reflective region 142_1A is configured to reflect all wavelength beams. As such, more first sub-laser beams L11 and second sub-laser beams L12 may enter the corresponding first light homogenizing element 150 and the second light homogenizing element 160 at different angles, respectively. This increases the blue beam that passes through the center of the light homogenizing element, thereby enhancing the uniformity of the blue beam within the illumination beam and effectively addressing the challenge of inadequate distribution of the blue beam within the central angular space of the light homogenizing elements, as observed in conventional optical structures.

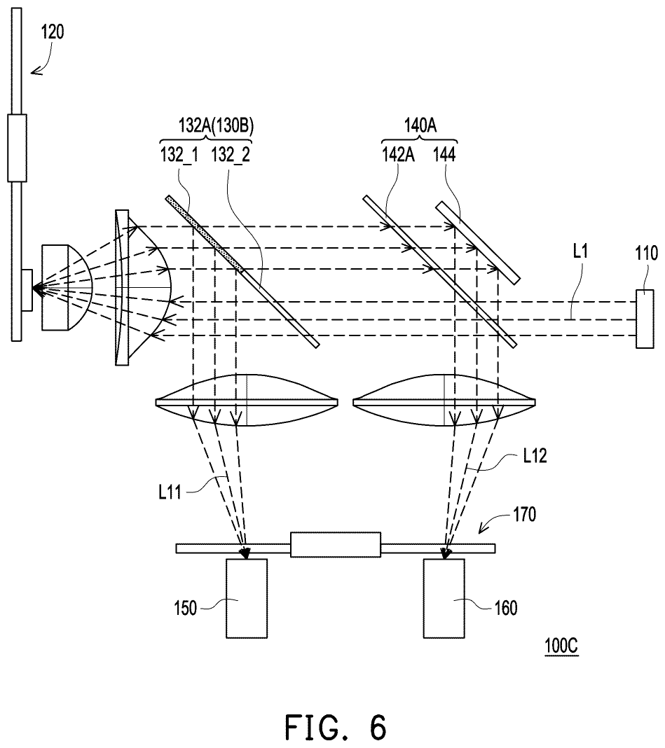

FIG. 6 is a schematic view illustrating an illumination system according to another embodiment of the invention. With reference to FIG. 6, the light transmission path at the timing of the blue beam is shown. An illumination system 100C provided in this embodiment is similar to the illumination system 100B depicted in FIG. 5. The difference between the two lies in that the second light splitting module 140B in FIG. 5 is modified in this embodiment to the second light splitting module 140A in the embodiment depicted in FIG. 4. In this embodiment, the reflective element 144 may be arranged away from the center of the second light homogenizing element 160, so that more first sub-laser beam L11 and second sub-laser beam L12 may enter the corresponding first light homogenizing element 150 and the second light homogenizing element 160 at different angles, respectively. This increases the blue beam that passes through the center of the light homogenizing element, thereby enhancing the uniformity of the blue beam within the illumination beam and effectively addressing the challenge of inadequate distribution of the blue beam within the central angular space of the light homogenizing elements, as observed in conventional optical structures.

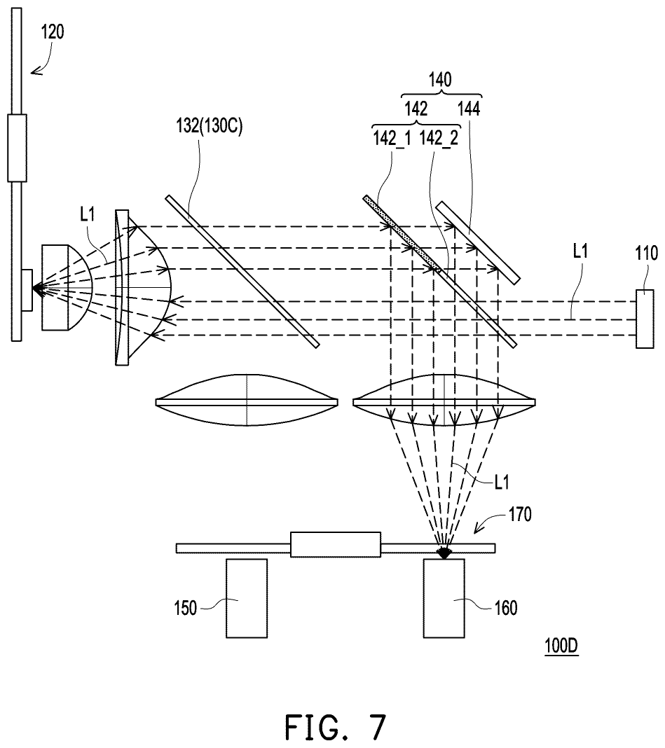

FIG. 7 is a schematic view illustrating an illumination system according to another embodiment of the invention. With reference to FIG. 7, the light transmission path at the timing of the blue beam is shown. The illumination system 100D provided in this embodiment is similar to the illumination system 100 depicted in FIG. 1A. The difference between the two lies in that the first light splitting module 130C provided in this embodiment simply includes the first light splitting element 132. As such, the blue beam passing through the center of the light homogenizing element is increased, thereby enhancing the uniformity of the blue beam within the illumination beam and effectively addressing the challenge of inadequate distribution of the blue beam within the central angular space of the light homogenizing elements, as observed in conventional optical structures.

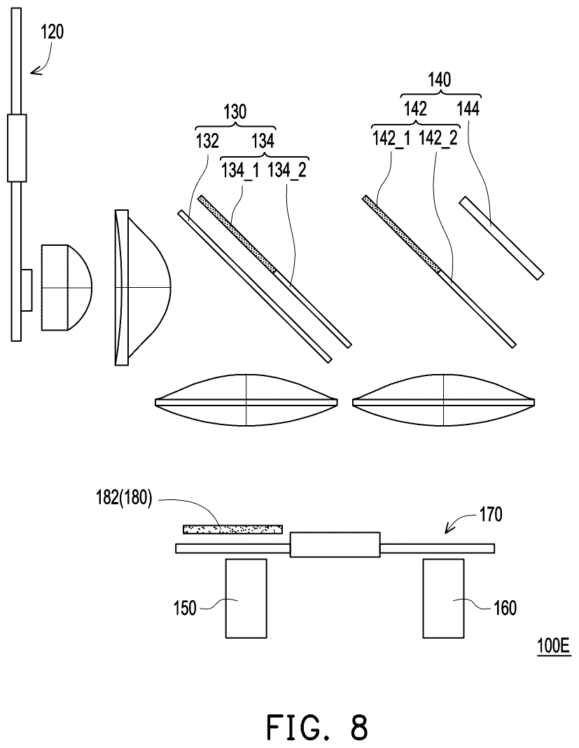

FIG. 8 is a schematic view illustrating an illumination system according to another embodiment of the invention. Please refer to FIG. 2, FIG. 3, and FIG. 8 simultaneously. An illumination system 100E provided in this embodiment is similar to the illumination system 100 depicted in FIG. 1A. For easy explanation, FIG. 8 does not show the light transmission path, and the light transmission path described below may be referred to as what is depicted in FIG. 1A to FIG. 1D. The difference between the two lies in that an illumination system 100E provided in this embodiment further includes a second filter device 180. The second filter device 180 includes a filter 182, which is configured to be located between the first light splitting module 130 and the first light homogenizing element 150. For instance, in this embodiment, the filter 182 is a green beam filter that allows the light beam with the blue beam waveband to pass through and is configured to allow the laser beam L1 and the first portion L21 of the excited beam L2 to pass through. Specifically, compared to the first filter region 172 in the first filter device 170, the filter 182 in the second filter device 180 may filter the green beam with a narrower waveband. As a result, the green beam of the first portion L21 of the excited beam L2 that passes through the filter 182 exhibits enhanced purity. The filter 182 may be directly fixed onto the light transmission path between the first light splitting module 130 and the first light homogenizing element 150, or the filter 182 is actively switched onto the light transmission path between the first light splitting module 130 and the first light homogenizing element 150 according to different scenarios by a switch element (not shown). Accordingly, when the second filter device 180 is disposed between the first light splitting module 130 and the first light homogenizing element 150, the first portion L21 of the excited beam L2 from the first light splitting module 130 passes through the filter 182 of the second filter device 180 and the first filter region 172 in the first filter device 170 corresponding to a position of the first light homogenizing element 150, so as to generate the first color beam (i.e., the green beam with a better color gamut). The first sub-laser beam L11 of the laser beam L1 from the first light splitting module 130 passes through the filter 182 of the second filter device 180 and the transparent region 176 in the first filter device 170 corresponding to the position of the first light homogenizing element 150, so as to be transmitted to the first light homogenizing element 150. As such, the composition of the green beam may exhibit enhanced purity, thereby enhancing the color gamut of the green beam. In this embodiment, note that the second filter device 180 is specifically configured to be located between the first light splitting module 130 and the first filter device 170; however, in other embodiments, the second filter device 180 may also be disposed between the first filter device 170 and the first light homogenizing element 150, which should however not be construed as a limitation to the invention.

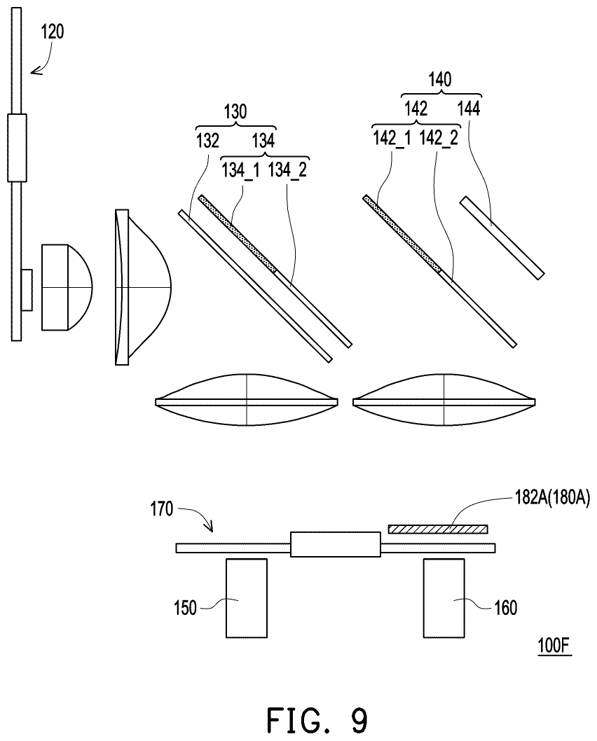

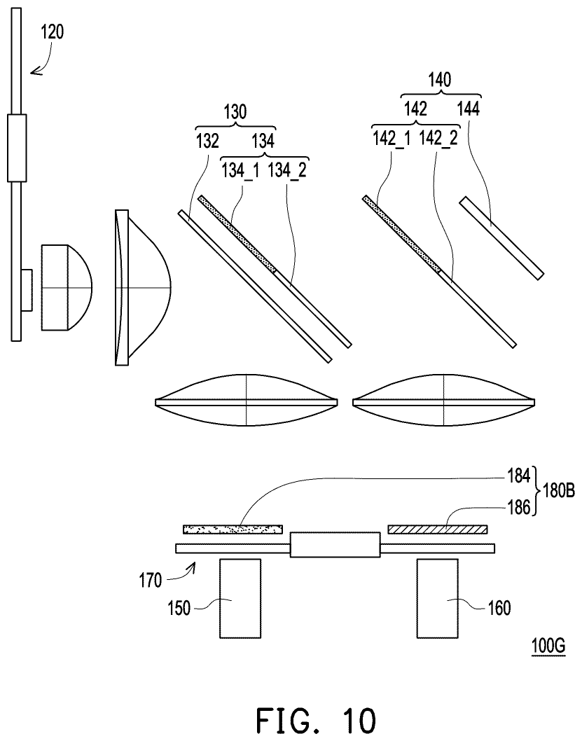

FIG. 9 is a schematic view illustrating an illumination system according to another embodiment of the invention. With reference to FIG. 2, FIG. 3, and FIG. 9, an illumination system 100F provided in this embodiment is similar to the illumination system 100 depicted in FIG. 1A. For easy explanation, FIG. 9 does not show the light transmission path, and the light transmission path described below may be referred to as what is depicted in FIG. 1A to FIG. 1D. The difference between the two lies in that the illumination system 100F provided in this embodiment further includes a second filter device 180A. The second filter device 180A includes a filter 182A, which is configured to be located between the second light splitting module 140 and the second light homogenizing element 160. For instance, in this embodiment, the filter 182A is a red filter that allows the light beam with the blue beam waveband to pass through and is configured to allow the laser beam L1 and the second portion L22 of the excited beam L2 to pass through. Specifically, compared to the second filter region 174 in the first filter device 170, the filter 182A in the second filter device 180A may filter the red beam with a narrower waveband. As a result, the red beam of the second portion L22 of the excited beam L2 that passes through the filter 182A exhibits enhanced purity. The filter 182A may be directly fixed onto the light transmission path between the second light splitting module 140 and the second light homogenizing element 160, or the filter 182A is actively switched onto the light transmission path between the second light splitting module 140 and the second light homogenizing element 160 according to different scenarios by a switch element (not shown). In other words, in an embodiment, the illumination system 100E in FIG. 8 and the illumination system 100F in FIG. 9 may have the same structure, and the filter 182/182A may be actively switched onto the light transmission path between the first light splitting module 130 and the first light homogenizing element 150 or onto the light transmission path between the second light splitting module 140 and the second light homogenizing element 160, which should however not be construed as a limitation to the invention. Therefore, when the second filter device 180 is configured to be located between the second light splitting module 140 and the second light homogenizing element 160, the second portion L22 of the excited beam L2 from the second light splitting module 140 passes through the filter 182A of the second filter device 180A and the second filter region 174 in the first filter device 170 corresponding to a position of the second light homogenizing element 160, so as to generate the second color beam (i.e., the red beam with a better color gamut). The second sub-laser beam L12 of the laser beam L1 from the second light splitting module 140 passes through the filter 182A of the second filter device 180A and the transparent region 176 in the first filter device 170 corresponding to the position of the second light homogenizing element 160, so as to be transmitted to the second light homogenizing element 160. As such, the composition of the red beam may exhibit enhanced purity, thereby enhancing the color gamut of the red beam. In this embodiment, note that the second filter device 180A is specifically configured to be located between the second light splitting module 140 and the first filter device 170; however, in other embodiments, the second filter device 180A may also be disposed between the first filter device 170 and the second light homogenizing element 160, which should however not be construed as a limitation to the invention.

FIG. 10 is a schematic view illustrating an illumination system according to another embodiment of the invention. With reference to FIG. 10, for easy explanation, FIG. 10 does not show the light transmission path, and the light transmission path described below may be referred to as what is depicted in FIG. 1A to FIG. 1D. An illumination system 100G provided in this embodiment is similar to the illumination system 100E shown in FIG. 8. The difference between the two lies that the filter 180B provided in this embodiment includes a first filter 184 and a second filter 186. The first filter 184 is movably disposed between the first light splitting module 130 and the first light homogenizing element 150. The second filter 186 is movably disposed between the second light splitting module 140 and the second light homogenizing element 160. The second filter device 180B further includes a switch element (not shown) configured to switch a light path where the first filter 184 enters and exits between the first light splitting module 130 and the first light homogenizing element 150 and switch a light path where the second filter 186 enters and exits between the second light splitting module 140 and the second light homogenizing element 160.

To sum up, the illumination system and the projection device, as described in one or more embodiments of the invention, offer at least one of the following advantages. In the illumination system and the projection device provided herein, the illumination system includes the excitation light source, the wavelength conversion device, the first light splitting module, the second light splitting module, the first light homogenizing element, and the second light homogenizing element. The laser beam provided by the excitation light source, through the optical manipulation facilitated by the first and second light splitting modules, yields the first sub-laser beam and the second sub-laser beam, which are respectively directed to the first and second light homogenizing elements to constitute the blue beam within the illumination beam. Consequently, the blue beam that traverses through the center of the light homogenizing elements may be increased, enhancing the uniformity of the blue beam within the illumination beam and effectively addressing the challenge of inadequate distribution of the blue beam within the central angular space of the light homogenizing elements, as observed in conventional optical structures.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, configured to provide an illumination beam and comprising an excitation light source, a wavelength conversion device, a first light splitting module, a second light splitting module, a first light homogenizing element, and a second light homogenizing element, wherein:
the excitation light source is configured to provide a laser beam;
the wavelength conversion device is disposed on a transmission path of the laser beam and configured to convert the laser beam into an excited beam or reflect the laser beam at different timing;
the first light splitting module is disposed between the wavelength conversion device and the second light splitting module and configured to allow the laser beam from the excitation light source to pass through, reflect a first sub-laser beam of the laser beam from the wavelength conversion device to the first light homogenizing element, and allow a second sub-laser beam of the laser beam from the wavelength conversion device to pass through;
the second light splitting module is disposed between the excitation light source and the first light splitting module and configured to allow the laser beam from the excitation light source to pass through and reflect the second sub-laser beam from the first light splitting module to the second light homogenizing element;
the first light homogenizing element is disposed on a transmission path of the first sub-laser beam from the first light splitting module; and
the second light homogenizing element is configured on a transmission path of the second sub-laser beam from the second light splitting module, and the illumination beam comprises the first sub-laser beam, the second sub-laser beam, and the excited beam.

2. The illumination system according to claim 1, wherein the wavelength conversion device comprises at least one first wavelength conversion region and at least one reflective region arranged alternately around a rotation axis, wherein:
the at least one first wavelength conversion region is configured to convert the laser beam into the excited beam; and
the at least one reflective region is configured to reflect the laser beam.

3. The illumination system according to claim 2, wherein the wavelength conversion device further comprises at least one second wavelength conversion region arranged around the rotation axis, the at least one second wavelength conversion region is configured to convert the laser beam into the excited beam, and a conversion wavelength of the at least one second wavelength conversion region is different from a conversion wavelength of the at least one first wavelength conversion region.

4. The illumination system according to claim 1, wherein the first light splitting module comprises a first light splitting element and a semi-reflective and semi-transmissive element, wherein:
the first light splitting element is disposed between the semi-reflective and semi-transmissive element and the wavelength conversion device and configured to reflect a first portion of the excited beam, allow the first portion of the excited beam to be transmitted toward the first light homogenizing element, and allow a second portion of the excited beam and the laser beam to pass through; and
the semi-reflective and semi-transmissive element is disposed between the first light splitting element and the second light splitting module and configured to allow the second sub-laser beam of the laser beam from the first light splitting element and the second portion of the excited beam to pass through and reflect the first sub-laser beam of the laser beam from the first light splitting element to the first light homogenizing element.

5. The illumination system according to claim 4, wherein the semi-reflective and semi-transmissive element comprises a semi-reflective and semi-transmissive region and a total transmissive region arranged adjacent to each other, wherein:
the semi-reflective and semi-transmissive region is located on the transmission path of the laser beam from the first light splitting element and configured to allow the second sub-laser beam of the laser beam from the first light splitting element and the second portion of the excited beam to pass through and reflect the first sub-laser beam of the laser beam from the first light splitting element; and
the total transmissive region is located on the transmission path of the laser beam between the excitation light source and the wavelength conversion device and configured to allow the laser beam to pass through.

6. The illumination system according to claim 4, wherein the second light splitting module comprises a second light splitting element and a reflective element, wherein:
the second light splitting element is disposed between the reflective element and the first light splitting module and configured to reflect the second portion of the excited beam from the first light splitting module, allow the second portion of the excited beam to be transmitted toward the second light homogenizing element, and allow the second sub-laser beam from the first light splitting module to pass through; and
the reflective element is disposed between the second light splitting element and the excitation light source and configured to reflect the second sub-laser beam from the first light splitting module to the second light homogenizing element.

7. The illumination system according to claim 1, further comprising a first filter device disposed between the first light splitting module and the first light homogenizing element and between the second light splitting module and the second light homogenizing element, the first filter device comprising two first filter regions, two second filter regions, and two transparent regions, which are symmetrically arranged and alternately arranged around a rotation axis, wherein:
the excited beam further comprises a first color beam and a second color beam;
the two first filter regions are configured to receive the first portion of the excited beam and generate the first color beam;
the two second filter regions are configured to receive the second portion of the excited beam and generate the second color beam, and a wavelength of the first portion of the excited beam is different from a wavelength of the second portion of the excited beam; and
the two transparent regions are configured to respectively allow the first sub-laser beam and the second sub-laser beam to pass through.

8. The illumination system according to claim 7, wherein the first filter device further comprises two third filter regions symmetrically arranged around the rotation axis and configured to allow the excited beam to pass through and generate the first color beam and the second color beam.

9. The illumination system according to claim 7, further comprising a second filter device, wherein:
the second filter device comprises a filter located between the first light splitting module and the first light homogenizing element, between the second light splitting module and the second light homogenizing element, or located between the first light splitting module and the first light homogenizing element and between the second light splitting module and the second light homogenizing element;
when the second filter device is configured to be located between the first light splitting module and the first light homogenizing element, the first portion of the excited beam from the first light splitting module passes through the filter of the second filter device and the first filter region in the first filter device corresponding to a position of the first light homogenizing element to generate the first color beam, and the first sub-laser beam of the laser beam from the first light splitting module passes through the filter of the second filter device and the transparent regions of the first filter device corresponding to the position of the first light homogenizing element to be transmitted to the first light homogenizing element; and
when the second filter device is located between the second light splitting module and the second light homogenizing element, the second portion of the excited beam from the second light splitting module passes through the filter of the second filter device and the second filter region in the first filter device corresponding to a position of the second light homogenizing element to generate the second color beam, and the second sub-laser beam of the laser beam from the second light splitting module passes through the filter of the second filter device and the transparent regions of the first filter device corresponding to the position of the second light homogenizing element to be transmitted to the second light homogenizing element.

10. The illumination system according to claim 9, wherein the filter comprises a first filter and a second filter, the first filter is movably disposed between the first light splitting module and the first light homogenizing element, the second filter is movably disposed between the second light splitting module and the second light homogenizing element, and the second filter device further comprises a switch element configured to switch a light path where the first filter enters or exits between the first light splitting module and the first light homogenizing element and switch a light path where the second filter enters or exits between the second light splitting module and the second light homogenizing element.

11. A projection device, comprising an illumination system, at least one light valve, and a projection lens, wherein:
the illumination system is configured to provide an illumination beam and comprises an excitation light source, a wavelength conversion device, a first light splitting module, a second light splitting module, a first light homogenizing element, and a second light homogenizing element, wherein:
the excitation light source is configured to provide a laser beam;
the wavelength conversion device is disposed on a transmission path of the laser beam and configured to convert the laser beam into an excited beam or reflect the laser beam at different timing;
the first light splitting module is disposed between the wavelength conversion device and the second light splitting module and configured to allow the laser beam from the excitation light source to pass through, reflect a first sub-laser beam of the laser beam from the wavelength conversion device to the first light homogenizing element, and allow a second sub-laser beam of the laser beam from the wavelength conversion device to pass through;
the second light splitting module is disposed between the excitation light source and the first light splitting module and configured to allow the laser beam from the excitation light source to pass through and reflect the second sub-laser beam from the first light splitting module to the second light homogenizing element;
the first light homogenizing element is disposed on a transmission path of the first sub-laser beam from the first light splitting module; and
the second light homogenizing element is configured on a transmission path of the second sub-laser beam from the second light splitting module, and the illumination beam comprises the first sub-laser beam, the second sub-laser beam, and the excited beam;
the at least one light valve is disposed on a transmission path of the illumination beam and configured to convert the illumination beam into an image beam; and
the projection lens is disposed on a transmission path of the image beam and configured to project the image beam out of the projection device.

12. The projection device according to claim 11, wherein the wavelength conversion device comprises at least one first wavelength conversion region and at least one reflective region arranged alternately around a rotation axis, wherein:
the at least one first wavelength conversion region is configured to convert the laser beam into the excited beam; and
the at least one reflective region is configured to reflect the laser beam.

13. The projection device according to claim 12, wherein the wavelength conversion device further comprises at least one second wavelength conversion region arranged around the rotation axis, the at least one second wavelength conversion region is configured to convert the laser beam into the excited beam, and a conversion wavelength of the at least one second wavelength conversion region is different from a conversion wavelength of the at least one first wavelength conversion region.

14. The projection device according to claim 11, wherein the first light splitting module comprises a first light splitting element and a semi-reflective and semi-transmissive element, wherein:
the first light splitting element is disposed between the semi-reflective and semi-transmissive element and the wavelength conversion device and configured to reflect a first portion of the excited beam, allow the first portion of the excited beam to be transmitted toward the first light homogenizing element, and allow a second portion of the excited beam and the laser beam to pass through; and
the semi-reflective and semi-transmissive element is disposed between the first light splitting element and the second light splitting module and configured to allow the second sub-laser beam of the laser beam from the first light splitting element and the second portion of the excited beam to pass through and reflect the first sub-laser beam of the laser beam from the first light splitting element to the first light homogenizing element.

15. The projection device according to claim 14, wherein the semi-reflective and semi-transmissive element comprises a semi-reflective and semi-transmissive region and a total transmissive region arranged adjacent to each other, wherein:
the semi-reflective and semi-transmissive region is located on the transmission path of the laser beam from the first light splitting element and configured to allow the second sub-laser beam of the laser beam from the first light splitting element and the second portion of the excited beam to pass through and reflect the first sub-laser beam of the laser beam from the first light splitting element; and
the total transmissive region is located on the transmission path of the laser beam between the excitation light source and the wavelength conversion device and configured to allow the laser beam to pass through.

16. The projection device according to claim 14, wherein the second light splitting module comprises a second light splitting element and a reflective element, wherein:
the second light splitting element is disposed between the reflective element and the first light splitting module and configured to reflect the second portion of the excited beam from the first light splitting module, allow the second portion of the excited beam to be transmitted toward the second light homogenizing element, and allow the second sub-laser beam from the first light splitting module to pass through; and
the reflective element is disposed between the second light splitting element and the excitation light source and configured to reflect the second sub-laser beam from the first light splitting module to the second light homogenizing element.

17. The projection device according to claim 11, wherein the illumination system further comprises a first filter device disposed between the first light splitting module and the first light homogenizing element and between the second light splitting module and the second light homogenizing element, the first filter device comprising two first filter regions, two second filter regions, and two transparent regions, which are symmetrically arranged and alternately arranged around a rotation axis, wherein:
the excited beam further comprises a first color beam and a second color beam;
the two first filter regions are configured to receive the first portion of the excited beam and generate the first color beam;
the two second filter regions are configured to receive the second portion of the excited beam and generate the second color beam, and a wavelength of the first portion of the excited beam is different from a wavelength of the second portion of the excited beam; and
the two transparent regions are configured to respectively allow the first sub-laser beam and the second sub-laser beam to pass through.

18. The projection device according to claim 17, wherein the first filter device further comprises two third filter regions symmetrically arranged around the rotation axis and configured to allow the excited beam to pass through and generate the first color beam and the second color beam.

19. The projection device according to claim 17, wherein the illumination system further comprises a second filter device, wherein:
the second filter device comprises a filter located between the first light splitting module and the first light homogenizing element, between the second light splitting module and the second light homogenizing element, or located between the first light splitting module and the first light homogenizing element and between the second light splitting module and the second light homogenizing element;
when the second filter device is configured to be located between the first light splitting module and the first light homogenizing element, the first portion of the excited beam from the first light splitting module passes through the filter of the second filter device and the first filter region in the first filter device corresponding to a position of the first light homogenizing element to generate the first color beam, and the first sub-laser beam of the laser beam from the first light splitting module passes through the filter of the second filter device and the transparent regions of the first filter device corresponding to the position of the first light homogenizing element to be transmitted to the first light homogenizing element; and
when the second filter device is located between the second light splitting module and the second light homogenizing element, the second portion of the excited beam from the second light splitting module passes through the filter of the second filter device and the second filter region in the first filter device corresponding to a position of the second light homogenizing element to generate the second color beam, and the second sub-laser beam of the laser beam from the second light splitting module passes through the filter of the second filter device and the transparent regions of the first filter device corresponding to the position of the second light homogenizing element to be transmitted to the second light homogenizing element.

20. The projection device according to claim 19, wherein the filter comprises a first filter and a second filter, the first filter is movably disposed between the first light splitting module and the first light homogenizing element, the second filter is movably disposed between the second light splitting module and the second light homogenizing element, and the second filter device further comprises a switch element configured to switch a light path where the first filter enters or exits between the first light splitting module and the first light homogenizing element and switch a light path where the second filter enters or exits between the second light splitting module and the second light homogenizing element.
